(19) United States
(12) Patent Application Publication
(10) Pub. No.: US 2009/0150467 A1
(43) Pub. Date: Jun. 11, 2009

(54) METHOD OF GENERATING PSEUDO-RANDOM NUMBERS

(75) Inventors: Heike B. Neumann, Hamburg (DE); Steffen Scholze, Berlin (DE); Matthias Voegeler, Hamburg (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/090,691

(22) PCT Filed: Oct. 10, 2006
(86) PCT No.: PCT/IB06/53723

§ 371 Date: Aug. 8, 2008

(30) Foreign Application Priority Data
Oct. 19, 2005 (EP) 05109728.5
Oct. 10, 2006 (IB) PCT/IB2006/053723

(51) Int. Cl. G06F 7/58

(52) U.S. Cl. 708/254

(57) ABSTRACT

A method of generating a pseudo-random number by means of an iteration, comprising at least two iteration steps, applied to a one-way function, wherein the one-way function, based on a start value and a key, generates part of the pseudo-random number and wherein the iteration is initialized with a random start value and a random key, and wherein, in each iteration step, both the start value and the key for an iteration step are determined from the part of the pseudo-random number determined in the previous iteration step using the one-way function.

The invention relates to a method of generating pseudo-random numbers by iterative application of a one-way function, wherein the one-way function, based on a start value and a key, generates a pseudo-random number and wherein the iteration begins with a random start value and a random key, and also to a data carrier comprising corresponding program code.

A known concept for generating pseudo-random numbers consists of pseudo-random number generators using secure one-way functions f(k, s), wherein k is a cryptographic key and s is a randomly selected start value. Such a key k is selected according to a predefined distribution and is used during the generation of pseudo-random numbers by the pseudo-random number generators. The key k remains the same during the entire generation process. Once a start value s has been selected, the pseudo-random numbers xᵢ are generated iteratively in accordance with the following rule:

x₁=f(k,s)

xᵢ=f(k,xᵢ₋₁) where i>1.

Typically, the length of pseudo-random numbers generated in this way is limited. Once the predefined limit has been reached, the pseudo-random number generator is reinitialized, with the start value s being reselected. The key k continues to remain the same.

One disadvantage of this implementation is that it is possible for an attacker who knows the cryptographic key k to calculate all the random numbers since the last initialization to the next initialization. This property thus considerably restricts this class of pseudo-random number generators.

It is furthermore known, from WO 2005/029315 A1, also to use a new cryptographic key k in addition to the new start value s upon initialization of a pseudo-random number generator. Moreover, when calculating the individual pseudo-random numbers, this cryptographic key k is recalculated each time from the start value s. The disadvantage with this method is that the next start value s+1 in each case is intermediately stored in a non-volatile memory during the calculation of a random number. An attacker can thus compromise the internal status of the pseudo-random number generator, for example if he manages to read the respective next start value s+1 from the non-volatile memory or even manipulate it.

The object of the present invention is to provide a method of generating pseudo-random numbers which at least partially avoids the aforementioned disadvantages. This object is achieved by the method as claimed in claim 1 and by the data carrier as claimed in claim 9. Advantageous further developments are defined in the dependent claims.

The invention provides a method of generating a pseudo-random number by means of an iteration, comprising at least two iteration steps, applied to a one-way function, wherein the one-way function, based on a start value and a key, generates part of the pseudo-random number and wherein the iteration is initialized with a random start value and a random key, and wherein, in each iteration step, both the start value and the key for an iteration step are determined from the part of the pseudo-random number determined in the previous iteration step using the one-way function.

The start value and key required for an iteration step are generated directly from the part of the pseudo-random number of the previous iteration step. Start value and key are not intermediately stored. Reading or alteration of these values by an attacker is thus not possible.

In a further embodiment, the part of the pseudo-random number determined in the respective previous iteration step using the one-way function is split into two portions, wherein one portion is used for determining both the start value and the key for an iteration step and the other portion is part of the pseudo-random number of the previous iteration step.

The method of generating a pseudo-random number comprises the following steps:
a first step for defining a random start value and a random key;
a second step for determining part of the pseudo-random number using the one-way function based on a start value and a key, wherein in the first iteration step the start value corresponds to the random start value and the key corresponds to the random key from the first step;
a third step for splitting the part of the pseudo-random number determined in the second step into two portions;
a fourth step for determining both a new start value and a new key from one of the two portions determined in step three, wherein the other of the two portions determined in step three is part of the pseudo-random number;
repetition of steps two to four until a predefined number of repetitions has been reached.

In the fourth step, one of the two portions determined in step three is split into two sub-portions, wherein the new start value consists of the first sub-portion and the new key consists of the second sub-portion. It is also possible for the new start value to consist of the second sub-portion and for the new key to consist of the first sub-portion.

In a further embodiment, in each case only a randomly selected part of the determined sub-portions is used to determine the key and the start value.

This has the particular advantage that the selected parts of the determined sub-portions change with each iteration step. Back-calculation of the randomly selected parts from the key and the start value is no longer possible.

In the fourth step, only a randomly selected part of the other of the two portions determined in step three is used as part of the pseudo-random number. In this case, too, no back-calculation of the randomly selected part from the part of the pseudo-random number is possible.

Also provided is a method of generating a combined pseudo-random number in a number of steps, wherein one step carries out the method of generating a pseudo-random number and wherein each step is initialized with a new random start value and a new random key.

Once the predefined limit is reached, the pseudo-random number to be generated can be extended by repeated application of the method of generating a pseudo-random number.

Also provided is a data carrier comprising a computer program for generating a pseudo-random number in accordance with the method according to the invention.

This invention thus provides an iterative method of generating pseudo-random numbers, in which, after each determined random number, the start value and the key of the one-way function are reinitialized for the next iteration step, wherein the start value and the key are determined directly from the respective previously determined random number. Since the start value and the key are not intermediately stored at any time, and since the determination of the random number is determined from random constituents of the respective previously determined random number, it is not possible for an attacker to read or manipulate start value and key or to analyze the one-way function from pairs of two successive random numbers in order to determine the key therefrom.

The invention thus provides a method of generating pseudo-random numbers by means of a pseudo-random number generator, which makes it much more difficult for an attacker to compromise the pseudo-random number generator and thus obtain the random numbers that have already been or are to be generated.

The invention will be further described with reference to an example of embodiment shown in the drawings to which, however, the invention is not restricted.

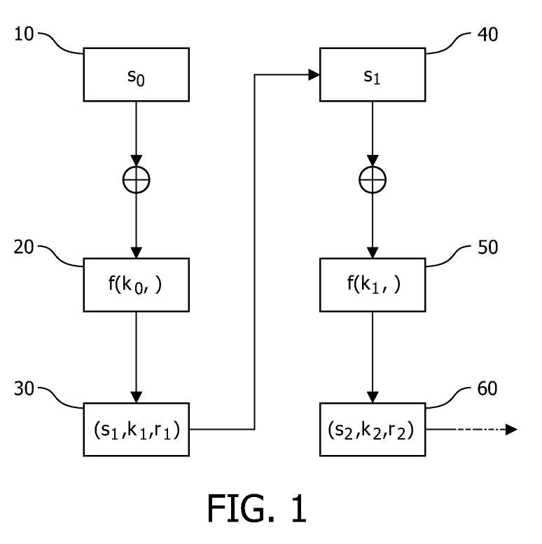

FIG. 1 shows an overview of the method according to the invention.

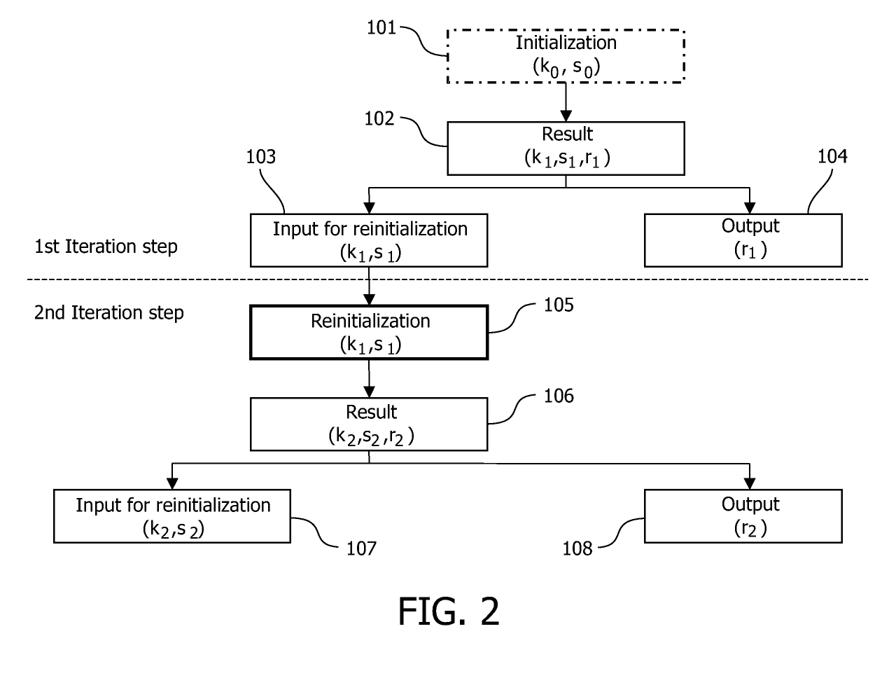

FIG. 2 shows the method according to the invention using two iteration steps.

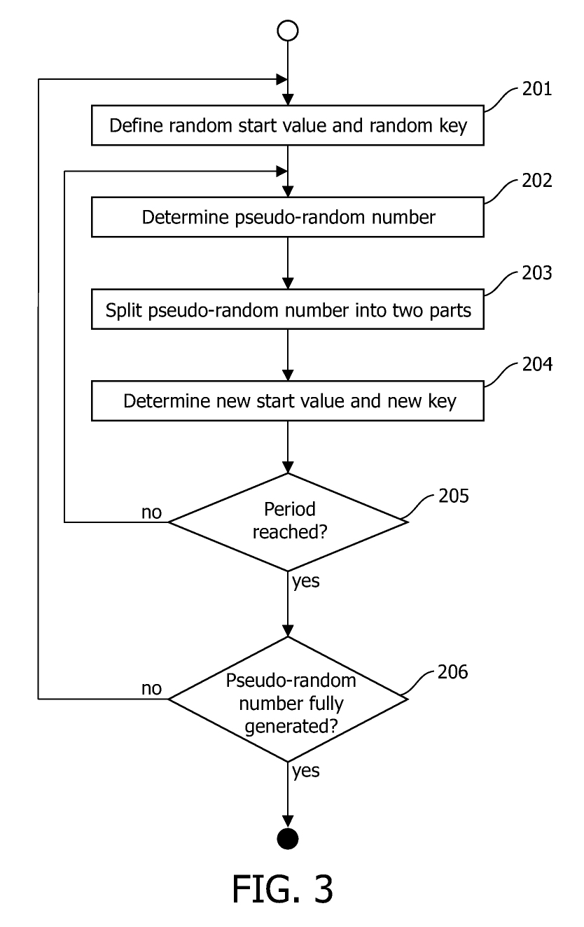

FIG. 3 shows a flowchart of the method according to the invention.

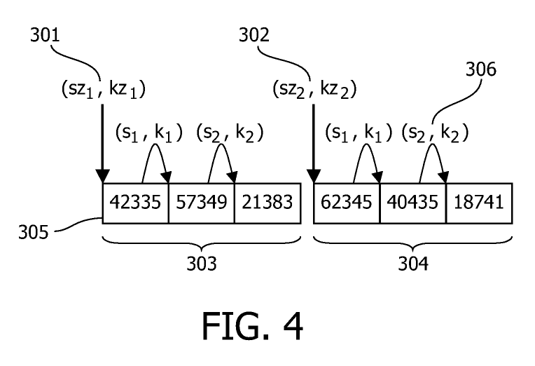

FIG. 4 shows the structure of a combined pseudo-random number.

A pseudo-random number generator generates a predefined number of random numbers. The pseudo-random number generators are initialized with a start value s₀ and a key k₀. Hereinbelow, the key k is assumed to be a cryptographic key.

Pseudo-random number generators have the property that their output becomes periodic after a certain number of run-throughs. This means that, after reaching the end of a period, the same random numbers as before would again be generated. In order to avoid this, the pseudo-random number generator according to this invention is initialized both with a new key k and with a new start value s. The key k and the start value s are in this case randomly selected.

FIG. 1 shows an overview of the method according to the invention. The pseudo-random number generator generates a set of random numbers by iterative application of a one-way function f. As the one-way function f, use may be made of either symmetrical one-way functions, such as for example 3DES (Triple-DES—Data Encryption Standard) or AES (Advanced Encryption Standard), or asymmetrical one-way functions such as the RSA function (according to Rivest, Shamir, Adleman) or discrete logarithm via finite groups. The one-way function f is also applied to a start value s and a key k.

An iteration comprises a number of iteration steps. In FIG. 1, steps 10, 20 and 30 form a first iteration step, while steps 40, 50 and 60 form a second iteration step. The pseudo-random number generator carries out, as necessary, a number of iterations consisting of a number of iteration steps in each case. Within one iteration, each iteration step is likewise initialized with a start value s and a key k. During the first iteration step of a respective iteration, the start value s of the iteration step corresponds to the start value s₀ of the pseudo-random number generator and the key k of the iteration step corresponds to the key k₀ of the pseudo-random number generator. Hereinbelow, the first start value and the first key of an iteration are denoted s₀ and k₀.

In the first iteration step 10, the pseudo-random number generator receives the start value s₀. The key k₀ is calculated therefrom. In a further embodiment, the pseudo-random number generator also receives the key k₀ in the first iteration step 10. In the next iteration step 20, the one-way function f is applied to the start value s₀ and the key k₀. The result of the function f(k₀, s₀) is then available in the iteration step 30. The triple (s₁, k₁, r₁) in step 30 here denotes the first generated random number. This random number is split into two portions t₁ and r₁. The start value sᵢ and the key k₁ for the second iteration step 40 to 60 are determined from t₁. The element r₁ is the first part of the pseudo-random number of the iteration.

The start value sᵢ and the key kᵢ for the respective next iteration step are determined as follows.

The values sᵢ and kᵢ required for the respective next iteration step are determined from the portion tᵢ of the random number of the respective current iteration step i. The portion tᵢ is split into two sub-portions, wherein the start value sᵢ is the first part of tᵢ and the key kᵢ is the second part of tᵢ. It is also possible for sᵢ to be the second part of tᵢ and for the key kᵢ to be the first part of tᵢ. The rest rᵢ of the random number serves as part of the pseudo-random number of the iteration.

In one particularly preferred embodiment, the portion tᵢ is split into two sub-portions, wherein in each case only randomly selected parts thereof are used as start value sᵢ and key kᵢ for the next iteration step. Preferably, only parts of rᵢ are then used as part of the overall pseudo-random number of the iteration. The advantage of this embodiment is that the pseudo-random number generator does not generate any pairs (rᵢ₋₁, rᵢ) of random numbers which would make it possible for an attacker to analyze the one-way function f and determine the key k therefrom.

The second iteration step in FIG. 1 uses the start value s₁—in step 40—and the key k₁—in step 50—in order to calculate the second random number (s₂, k₂, r₂) therefrom. This random number is again broken down into two portions, as described above, wherein the key and the start value for the next iteration step (not shown here) are determined from one portion and another part of the pseudo-random number of the iteration is determined from the other portion.

Once the iteration reaches the predefined limit, the iteration begins again from the start with step 10, wherein a new random start value s₀ and a new random key k₀ are used. Combined pseudo-random numbers are thus generated.

FIG. 2 shows the method according to the invention based on two iteration steps. The first iteration step begins with step 101, in which the pseudo-random number generator is initialized with the key k₀ and the start value s₀. Based on a one-way function f, the random number (k₁, s₁, r₁) is determined in step 102. The element r₁ (for instance 3256) serves as the output 104 of the first iteration step. The elements (k₁, s₁) serve as the input 103 for the second iteration step. Like the first iteration step, the second iteration step begins with an initialization 105. However, in this case, the values k₁ and sᵢ are determined from the result 102 of the first iteration step. Then, based on the one-way function f, the random number (k₂, s₂, r₂) is determined in step 106. The element r₂ (for instance 7158) serves as the output 108 of the second iteration step. The elements (k₂, s₂) can serve as the input 107 for a further iteration step. After two iteration steps, the generated pseudo-random number, consisting of the elements r₁ and r₂, would read 32567158.

FIG. 3 shows a flowchart of the method according to the invention. In the first step 201, the random start value and the random key are determined for initializing the pseudo-random number generator. Using these two values, part of the random number is determined in the next step 202. This part of the random number is broken down into two portions in step 203. One portion is used in the next step 204 to determine a new start value and a new key. The other portion is part of the overall pseudo-random number.

In step 205, a check is made to ascertain whether the predefined limit has been reached. If this is not the case, steps 202 to 204 are repeated, wherein the new values determined in step 204 are used to determine part of the random number in step 202. Once the end of the period has been reached, the method continues with step 206, in which a check is made to ascertain whether the combined pseudo-random number has been fully generated. If the combined pseudo-random number has not yet been fully generated, the method begins again with step 201, in which a new random start value and a new random key are determined. If the combined pseudo-random number has been fully generated, the method ends.

The result of the method is then a pseudo-random number consisting of the constituents determined in step 204.

FIG. 4 shows a combined pseudo-random number. This combined pseudo-random number consists of the six parts 305, wherein the first three parts have been generated by three iteration steps in a first iteration 303 and the last three parts have been generated by three iteration steps in a second iteration 304.

The first iteration 303 has been initialized with the random values (sz₁, kz₁) 301 and the second iteration with the random values (sz₂, kz₂) 302. Here, szᵢ is a random start value and kzᵢ is a random key of the iteration i.

The iteration steps I_{i,j} 305 are in each case initialized with the values (sⱼ₋₁, kⱼ₋₁) 306 determined from the previous iteration step Iᵢⱼ₋₁, wherein I_{i,j} is the iteration step j of the iteration i and j>0. The respective first iteration step I_{i,0} of an iteration i is initialized with the values (szᵢ, kzᵢ).

### LIST OF REFERENCES

10, 20, 30 steps of a first iteration
40, 50, 60 steps of a second iteration
101 initialization (1st iteration step)
102 result (1st iteration step)
103 input for 2nd iteration step (1st iteration step)
104 output (1st iteration step)
105 initialization (2nd iteration step)
106 result (2nd iteration step)
107 input for further iteration step (2nd iteration step)
108 output (2nd iteration step)
201 definition of random start value and random key (1st step)
202 determination of pseudo-random number (2nd step)
203 splitting of pseudo-random number (3rd step)
204 determination of new start value and new key (4th step)
205, 206 interrogation steps
301, 302 random start value and random key of an iteration
303, 304 iterations
305 iteration steps of an iteration
306 start value and key of an iteration step

1. A method of generating a pseudo-random number by an iteration, comprising at least two iteration steps, applied to a one-way function, wherein the one-way function, based on a start value and a key, generates part of the pseudo-random number and wherein the iteration is initialized with a random start value and a random key, characterized in that, in each iteration step, both the start value and the key for an iteration step are determined from the part of the pseudo-random number determined in the previous iteration step using the one-way function.

2. A method as claimed in claim 1, characterized in that the part of the pseudo-random number determined in the respective previous iteration step using the one-way function is split into two portions, wherein one portion is used for determining both the start value and the key for an iteration step and the other portion is the part of the pseudo-random number of the previous iteration step.

3. A method as claimed in claim 2, characterized in that the generation of a pseudo-random number comprises the following steps:
a first step for defining a random start value and a random key;
a second step for determining part of the pseudo-random number using the one-way function based on a start value and a key, wherein in the first iteration step the start value corresponds to the random start value and the key corresponds to the random key from the first step;
a third step for splitting the part of the pseudo-random number determined in the second step into two portions;
a fourth step for determining both a new start value and a new key from one of the two portions determined in step three, wherein the other of the two portions determined in step three is part of the pseudo-random number;
repetition of steps two to four until a predefined number of repetitions has been reached.

4. A method as claimed in claim 3, characterized in that, in the fourth step, one of the two portions determined in step threeis split into two sub-portions, wherein the new start value consists of the first sub-portion and the new key consists of the second sub-portion.

5. A method as claimed in claim 4, characterized in that the new start value consists of the second sub-portion and the new key consists of the first sub-portion.

6. A method as claimed in claim 5, characterized in that in each case only a randomly selected part of the determined sub-portions is used to determine the key and the start value.

7. A method as claimed in claim 6, characterized in that, in the fourth only a randomly selected part of the other of the two portions determined in step three is part of the pseudo-random number.

8. A method of generating a combined pseudo-random number in a number of steps, wherein firstly one step carries out a method as claimed in claim 1 and wherein each step is initialized with a new random start value and a new random key.

9. A data carrier comprising program code which, when loaded into a computer, carries out the method as claimed in claim 1.
